(19) United States
(12) Patent Application Publication
(10) Pub. No.: US 2016/0351909 A1
(43) Pub. Date: Dec. 1, 2016

(54) PARTICULATE ELECTRODE MATERIAL HAVING A COATING MADE OF A CRYSTALLINE INORGANIC MATERIAL AND/OR AN INORGANIC-ORGANIC HYBRID POLYMER AND METHOD FOR THE PRODUCTION THEREOF

(71) Applicant: FRAUNHOFER-GESELLSCHAFT ZUR FÖRDERUNG DER ANGEWANDTEN FORSCHUNG E.V., München (DE)

(72) Inventors: Andreas Bittner, Randersacker (DE); Uwe Guntow, Würzburg (DE); Birke-Elisabeth Olsowski, Veitshöchheim (DE); Jochen Schulz, Veitshöchheim (DE); Manfred Römer, Würzburg (DE); Moritz Milde, Würzburg (DE); Vilija Anfimovaite, Würzburg (DE)

(21) Appl. No.: 14/442,716

(22) PCT Filed: Nov. 19, 2013
(86) PCT No.: PCT/EP2013/074177

§ 371 Date: May 13, 2015

(30) Foreign Application Priority Data
Nov. 19, 2012 (DE) 10 2012 022 604.7
Nov. 19, 2012 (DE) 10 2012 022 606.3
Nov. 19, 2012 (DE) 10 2012 023 279.9

(51) Int. Cl. H01M 4/62; H01M 4/525; H01M 4/04; H01G 11/86; H01M 4/1391; H01M 4/36; H01G 11/26; H01G 11/50; H01M 4/505; H01M 4/131

(52) U.S. Cl. CPC H01M 4/628; H01M 4/505; H01M 4/525; H01M 4/0416; H01M 4/0471; H01M 4/131; H01M 4/1391; H01M 4/366; H01G 11/26; H01G 11/50; H01G 11/86

(57) ABSTRACT

According to the invention, a particulate electrode material is provided, which has high energy density, safety and longevity (stability relative to degradation and material fatigue). Furthermore, the electrode material is distinguished both by high electrical and high ionic conductivity and consequently achieves very low resistance values. Furthermore, a method for coating particulate electrode material is provided according to the invention, with which method the electrode material according to the invention can be produced. Finally, uses of the electrode material according to the invention are demonstrated.

According to the invention, a particulate electrode material is provided, which has high energy density, safety and longevity (stability relative to degradation and material fatigue). Furthermore, the electrode material is distinguished both by high electrical and high ionic conductivity and consequently achieves very low resistance values. Furthermore, a method for coating particulate electrode material is provided according to the invention, with which method the electrode material according to the invention can be produced. Finally, uses of the electrode material according to the invention are demonstrated.

One approach for the subsequently described innovation is surface passivation of electrode materials in lithium accumulators, which is durable and caused by reaction with the electrolyte. This is generally followed by a progressive degradation of the accumulator materials. It is ultimately responsible for the limited lifespan thereof.

These reactions are manifested particularly strongly in the case of high voltage loading. This means that the accumulators cannot use their full energy storage potential. The consequently produced solid-electrolyte-interphase (SEI) in addition causes resistance for the intercalation of charge carriers, i.e. both electrons and lithium ions. Limited current loadability which in turn limits the power density of these accumulators is associated therewith.

These negative effects have to date been reduced by finishing accumulator materials with particle coatings made of metal oxides or
fluorides (US 2011/0076556 A1, US 2011/0111298 A1).

It is in fact possible therewith to protect the active material particles from undesired reactions, however this improvement is associated with more difficult charge carrier intercalation—particularly of lithium ions. This is manifested in increased resistance due to the more difficult ion transport into the active material. The high resistance in turn has a disadvantageous effect on the energy- and power density of the batteries.

In order to be able to achieve wide application of new accumulator generations in stationary energy stores and electric vehicles, it is necessary to improve the materials used for this propose with respect to the energy density, power density, safety and longevity.

One object of the present invention is hence the provision of a coated electrode material, the coating of which has higher conductivity relative to the prior art.

The object is achieved by the coated particulate electrode material according to claim 1, the methods for coating particulate electrode material according to one of the claims 15, 21 and 25, the use of inorganic materials and hybrid polymers according to claim 26 and the use of the electrode material according to the invention according to claim 27. The dependent claims reveal advantageous developments.

According to the invention, a coated particulate electrode material is provided, comprising a particulate electrode material selected from the group consisting of lithium-intercalating and lithium-deintercalating substances, which material has, at least in regions,
a) a nanostructured coating which comprises at least one crystalline, particulate, inorganic material or consists thereof; and/or
b) a hybrid polymer coating which comprises at least one inorganic-organic hybrid polymer or consists thereof.

According to the invention, there is understood by the term “particulate” or the term “particle” not only round bodies but for example also bodies in the form of leaves, bars, wires and/or fibres. There is understood by the term “hybrid polymer” that chemically covalent bonds exist between the inorganic and the organic components (or phases) of the polymer.

The advantage of using a crystalline, particulate, inorganic material in the coating is that surface effects at the grain boundaries of the particles are utilised and, as a result of the charge carriers and free lattice places which are present there in greater quantities, the charge carrier transport into the electrode material is facilitated and hence improved. It is possible therewith to achieve not only the previous layer properties but in addition to achieve an improvement in the power density of electrode materials.

The advantage of using an inorganic-organic hybrid polymer in the coating is that the properties of hybrid polymers can be adjusted specifically by means of different functional groups. It is possible therewith to produce a coating which is distinguished by high stability, good flexibility and also in particular high ion conductivity. Hence, conductivity values of ≧10⁻⁴ S/cm and high energy- and power densities can be achieved. The thermal loadability of the hybrid polymers and also their chemical and electrochemical stability effect in addition an improvement in safety, longevity and high-voltage capacity of the electrode materials coated therewith. A further advantage is the weight of a hybrid polymer coating which is significantly less than previous coatings made of metal oxides or metal fluorides and consequently improves the specific performance parameters of the accumulator. Furthermore, the hybrid polymer coating is highly elastic. It is hence particularly suitable for electrode materials with high volume expansion, such as for example silicon (expansion: 300%-400%).

The advantage of using both a crystalline, particulate, inorganic material and an inorganic-organic hybrid polymer in the coating is that the coating is highly transmissive for electrons and ions. The reason is the composite structure of the coating which is distinguished both by hard, e⁻-conducting, inorganic crystallite regions and by flexible, Li⁺-conducting, inorganic-organic hybrid polymer regions. Segmentation of both regions is optimised with this new coating down to the nanoscale, as a result of which the best possible intercalation of both charge carriers and hence a reduction in the associated resistance is made possible. Due to the high flexibility of the many small hybrid polymer regions and also the great hardness of the semiconducting crystal grains, this innovative type of coating is particularly resistant to material fatigue. This applies both to the battery production phase and in operation. It is hence particularly suitable for electrode materials with high volume expansion, such as for example silicon (expansion: 300%-400%). In addition there also results the high thermal, chemical and electrochemical stability of both materials which hence ensures permanent protection as a result of this new type of coating.

The coated particulate electrode material can be characterised in that the inorganic material has a particle size in the range of 0.5 to 500 nm, preferably of 1 to 50 nm, particularly preferred of 1 to 20 nm, in particular of 1 to 10 nm.

The inorganic material can concern a semiconducting to conducting material.

The electrode material according to the invention can be suitable for the production of energy stores which have a power density up to 15,000 W/kg, preferably of 1,000 W/kg to 15,000 W/kg and/or an energy density of 150 Wh/kg to 1,000 Wh/kg.

Preferably, the electrode material is selected from the group consisting of carbon, alloys of Si, Li, Ge, Sn, Al, Sb, Li₄Ti₅O₁₂, Li_{4-y}A_{y}Ti₅₋ₓMₓO₁₂ (A=Mg, Ca, Al; M=Ge, Fe, Co, Ni, Mn, Cr, Zr, Mo, V, Ta or a combination thereof), Li(Ni,Co,Mn)O₂, Li₁₋ₓ(M,N)₁₋ₓO₂ (M=Mn, Co, Ni or a combination thereof; N=Al, Ti, Fe, Cr, Zr, Mo, V, Ta, Mg, Zn, Ga, B, Ca, Ce, Y, Nb, Sr, Ba, Cd or a combination thereof), (Li,A)ₓ(M,N)_{z}O_{v-w}X_{w} (A=alkali-, alkaline earth metal, lanthanoide or a combination thereof; M=Mn, Co, Ni or a combination thereof; N=Al, Ti, Fe, Cr, Zr, Mo, V, Ta, Mg, Zn, Ga, B, Ca, Ce, Y, Nb, Sr, Ba, Cd or a combination thereof; X=F, Si), LiFePO₄, (Li,A)₂(M,B)PO₄ (A or B=alkali-, alkaline earth metal, lanthanoide or a combination thereof; M=Fe, Co, Mn, Ni, Ti, Cu, Zn, Cr or a combination thereof), LiVPO₄F, (Li,A)₂(M,B)PO₄F (A or B=alkali-, alkaline earth metal, lanthanoide or a combination thereof; M=Fe, Co, Mn, Ni, Ti, Cu or a combination thereof), Li₃V₂PO₄, Li(Mn,Ni)₂O₄, Li₁₋ₓ(M,N)₂₋ₓO₄ (M=Mn; N=Co, Ni, Fe, Al, Ti, Cr, Zr, Mo, V, Ta or a combination thereof) and mixtures or combinations of the same.

The inorganic material can be selected from the group consisting of chalcogenides, halogenides, silicides, borides, nitrides, phosphides, arsenides, antimonides, carbides, carbonites, carbonitrides and oxynitrides of the elements Zn, Al, In, Sn, Ti, Si, Li, Zr, Hf, V, Nb, Cr, Mo, W, Mn, Co, Ni, Fe, Ca, Ta, Cd, Ce, Be, Bi, Sc, Rh, Pd, Ag, Cd, Ru, La, Pr, Nd, Sm, Eu, Gd, Mg, Cu, Y, Fe, Ga, Ge, Hg, S, Se, Sb, Te, B, C and I, and also the pure elements and mixtures or combinations of the same.

In a preferred embodiment, the nanostructured inorganic coating is porous at least in regions.

The inorganic-organic hybrid polymer can be based on cohydrolysis and cocondensation of organically substituted silanes with hydrolysable functionalities. The inorganic framework of the hybrid polymers can consist of an Si—O—Si network into which in addition elements, preferably semimetals or metals selected from the group M=Li, B, Ge, Al, Zr and Ti, can be incorporated as heteroatoms so that Si—O-M or Si—O⁻-M⁺- and M-O-M bonds are produced. Hence, material properties, such as the conductivity and also the thermal, chemical and electrochemical stability, can be adjusted specifically.

Likewise, the type of organic modification which is used has however a substantial influence on the material properties. Via non-reactive groups which act as network converters, such as for example alkyl-, phenyl-, (per)fluoroalkyl, (per)fluoroaryl, polyether, isocyanate or nitrile groups and also organic carbonates, the toughness and flexibility of the hybrid polymer for example can be influenced. With reactive groups which serve as network formers, such as for example vinyl-, methacryl-, allyl-, styryl-, cyanurate- or epoxy groups, an additional organic network can be constructed via polymerisation reactions.

In a preferred embodiment, the inorganic-organic hybrid polymer comprises an inorganic-oxidic framework consisting of ion-conductive Si—O—Si bonds, this framework optionally comprising in addition oxidic heteroatoms selected from the group consisting of Li, B, Zr, Al, Ti, Ge, P, As, Mg, Ca, Cr, W and/or organic substituents (primarily bonded to Si) made of vinyl, alkyl, acryl, methacryl, epoxy, PEG, aryl, styryl, (per)fluoroalkyl, (per)fluoroaryl, nitrile, isocyanate or organic carbonates, and/or vinyl-, allyl-, acryl-, methacryl-, styrene-, epoxy- or cyanurate functionalities.

Into this network, for example lithium salts can be introduced in order to achieve increased ionic conductivity.

Consequently, the hybrid polymer comprises a lithium salt in a preferred embodiment. With introduction of a lithium salt into the hybrid polymer network, conductivity in the organic regions of the hybrid polymer is achievable in addition. As a result, the conductivity can be even further increased. The lithium salt is preferably selected from the group consisting of LiClO₄, LiAlO₄, LiAlCl₄, LiPF₆, LiSiF₆, LiBF₄, LiBr, LiI, LiSCN, LiSbF₆, LiAsF₆, LiTfa, LiDFOB, LiBOB, LiTFSI, LiCF₃SO₃, LiC₄F₉SO₃, LiN(CF₃SO₂)₂, LiN(C₂F₅SO₂)₂, LiC(CF₃SO₂)₃ and LiC(C₂F₅SO₂)₃.

The hybrid polymer coating can be a nanostructured hybrid polymer coating. Preferably, the hybrid polymer coating has a lithium-ion conductivity in the range of 10⁻⁷ S/cm to 1 S/cm, preferably of 10⁻⁶ S/cm to 5·10⁻³ S/cm, in particular of 10⁻⁴ S/cm to 10⁻³ S/cm.

The hybrid polymer coating can have, according to the invention, a layer thickness in the range of 1 to 500 nm, preferably of 1 to 50 nm, particularly preferred of 1 to 20 nm, in particular of 1 to 10 nm.

In a preferred embodiment, the hybrid polymer coating is elastic and has preferably a modulus of elasticity of 10 kPa to 100 MPa, particularly preferred 10 kPa to 1 MPa. In a further preferred embodiment, only temperatures above 300° C. lead to thermal degradation of the hybrid polymer coating.

The electrode material coated with hybrid polymer can be electrochemically stable at potentials ≧5 V vs Li/Li⁺. In addition, the electrode material coated with hybrid polymer can be distinguished by an operational life of 100 to 100,000 cycles.

In a preferred embodiment, the crystalline, particulate, inorganic material is electron-conducting and/or the inorganic-organic hybrid polymer is ion-conducting.

Furthermore, a first method according to the invention for coating particulate electrode material with a particulate, nanostructured coating is provided, in which
a) at least one precursor of a metal or metalloid compound or a metal or metalloid compound is dissolved or dispersed in a solvent;
b) at least one polymerisible, organic substance is added;
c) the solution is contacted with at least one particulate electrode material, electrode material with a nanostructured coating being produced; and
d) the coated electrode material is isolated and tempered.

This method is distinguished by high flexibility. Hence, dopings therewith are very readily possible, as a result of which a further improvement in conductivity can be achieved. Comparably low material costs, low technical outlay and simple high-scalability are further advantages of this method.

The method according to the invention can be characterised in that the polar solvent in step a) is selected from the group consisting of inorganic and organic solvents, in particular water and/or alcohol.

Furthermore, it is preferred that, before or after step a), the at least one precursor of a metal or metalloid compound or the metal or metalloid compound is contacted with an inorganic or organic acid, preferably nitric acid. The addition of an acid has the advantage that the solubility of the precursor of a metal or metalloid compound in the polar solvent is decisively improved.

The polymerisable, organic substance in step b) can comprise an acid or consist thereof, preferably an acid selected from the group consisting of organic and inorganic acids, preferably organic carboxylic acids with more than one acid functionality, in particular citric acid.

In addition, the polymerisable, organic substance in step b) can comprise an alcohol or consist thereof, preferably an alcohol selected from the group consisting of alcohols with more than one alcohol functionality, preferably polymeric alcohols with more than one alcohol functionality, in particular (poly-)ethylene glycol and/or (poly-)propylene glycol.

The tempering in step d) preferably comprises the following step(s):
a) drying of the particles, preferably at a temperature of 80 to 120° C.; and/or
b) pyrolysis and/or crystallisation of the particles, preferably at a temperature of 500 to 700° C.

The method according to the invention can be used for the production of the electrode material according to the invention.

Furthermore, a second method according to the invention for coating a particulate electrode material with a hybrid polymer coating is provided, in which
i) a sol made of an organically modified, polysiloxane-containing material is provided and is mixed with electrode material, selected from the group consisting of lithium-intercalating and lithium-deintercalating substances, and possibly with at least one organic solvent; and
ii) the organic solvent is separated, electrode material with a nanostructured hybrid polymer coating being produced; and
iii) the electrode material with the nanostructured hybrid polymer coating is isolated, dried and hardened.

There should be understood by a sol, a colloidal dispersion in a solvent.

In step i), at least one lithium salt and/or at least one hardener can hereby be added.

The organic solvent is preferably selected from the group consisting of organic solvents which dissolve the organically modified, polysiloxane-containing material.

This method according to the invention can be characterised in that, in step iii),
a) drying takes place a temperature of 30 to 50° C. for 20 to 40 min; and/or
b) hardening takes place at a temperature of 70 to 150° C. for 0.5 to 5 hours.

This method according to the invention can be used for the production of electrode material according to the invention.

In addition, a third method according to the invention for coating particulate electrode material with a nanostructured coating comprising a crystalline inorganic material and an inorganic-organic hybrid polymer is provided. This method comprises the steps:
a) implementation of the first method according to the invention; and
b) implementation of the second method according to the invention with the proviso that the coated electrode material from step d) of the first method is used as electrode material in step i) of the second method.

According to the invention, in addition the use of
a) inorganic materials, selected from the group consisting of chalcogenides, halogenides, silicides, borides, nitrides, phosphides, arsenides, antimonides, carbides, carbonites, carbonitrides and oxynitrides of the elements Zn, Al, In, Sn, Ti, Si, Li, Zr, Hf, V, Nb, Cr, Mo, W, Mn, Co, Ni, Fe, Ca, Ta, Cd, Ce, Be, Bi, Sc, Rh, Pd, Ag, Cd, Ru, La, Pr, Nd, Sm, Eu, Gd, Mg, Cu, Y, Fe, Ga, Ge, Hg, S, Se, Sb, Te, B, C and I, and also the pure elements and mixtures or combinations of the same;
   and/or
b) a hybrid polymer comprising a sol-gel material which is produced from organically substituted silanes with hydrolysable functionalities and optionally comprises lithium salt;
   is proposed for coating, preferably particulate and/or crystalline coating, of particulate electrode material or catalyst material.

In addition, it is proposed to use the electrode material coated according to the invention in energy stores, preferably in lithium accumulators and/or in double-layer capacitors.

Furthermore, the electrode material according to the invention can be used as catalyst material. The use as catalyst material has the advantage that both the large number of active centres made of the smallest crystal grains and the therewith resulting high specific surface ensure a particularly high catalytic activity of the layer material.

The subject according to the invention is intended to be explained in more detail with reference to the subsequent examples and Figures without wishing to restrict said subject to the specific embodiments illustrated here.

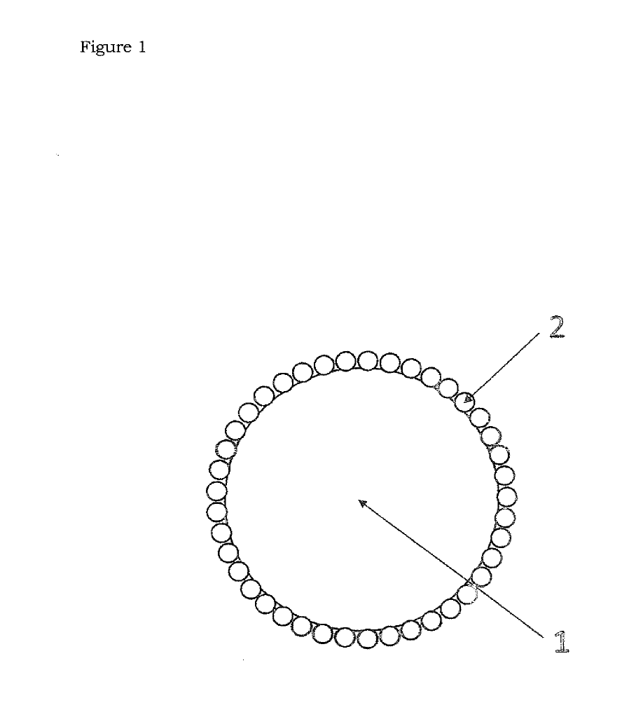

FIG. 1 shows the construction of an electrode material 1 with particulate, nanostructured coating 2, as a model.

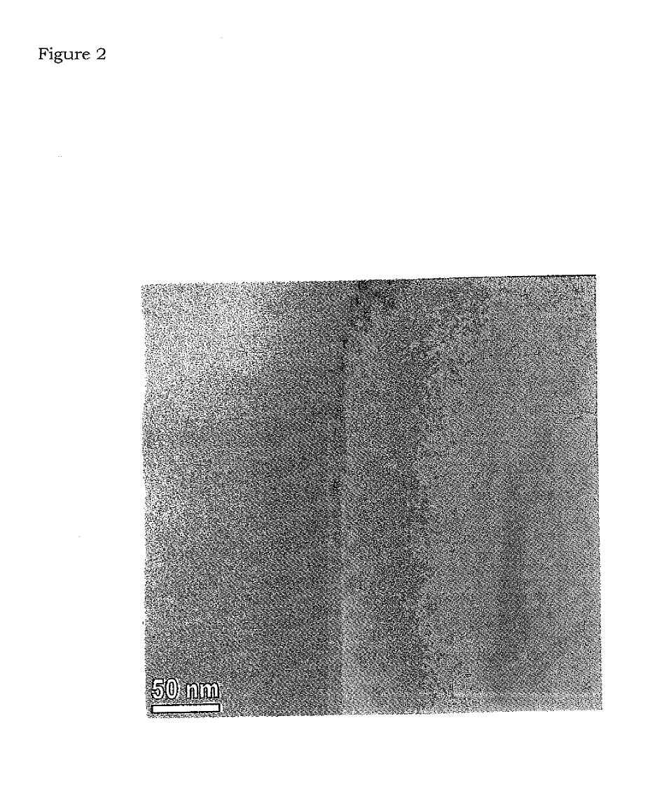

FIG. 2 shows the TEM image of the profile of an Li(Ni,Co,Mn)O₂ particle coated with particulate ZnO.

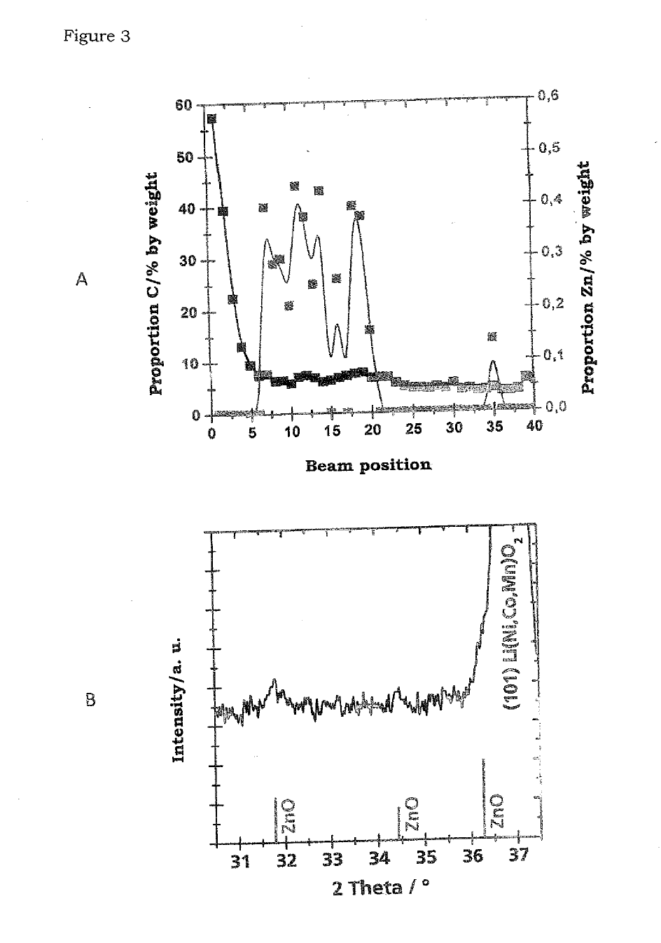

FIG. 3 shows the element profile (C: black; Zn: grey; Ni, Co, Mn, O not illustrated) through the surface of an Li(Ni,Co,Mn)O₂ particle coated with particulate ZnO, by means of EDX linescan of a TEM lamella made of particles embedded in “adhesive” (carbon) (FIG. 3A). Furthermore, the X-ray diffractogram of Li(Ni,Co,Mn)O₂ particles coated with particulate ZnO is shown (FIG. 3B).

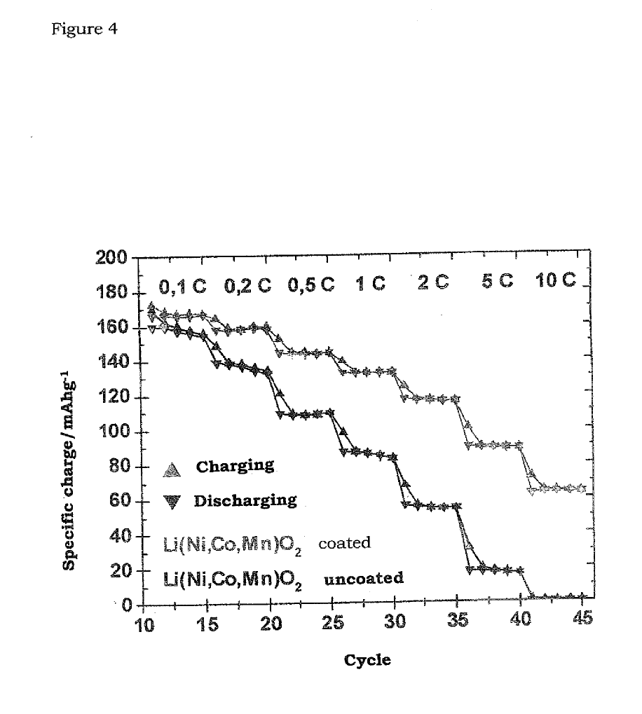

FIG. 4 shows charging measurements (black triangle with tip at the top) and discharging measurements (black triangle with tip at the bottom) of Li(Ni,Co,Mn)O₂ which is coated with particulate ZnO (grey upper curves) or is uncoated (black lower curves), at different C rates.

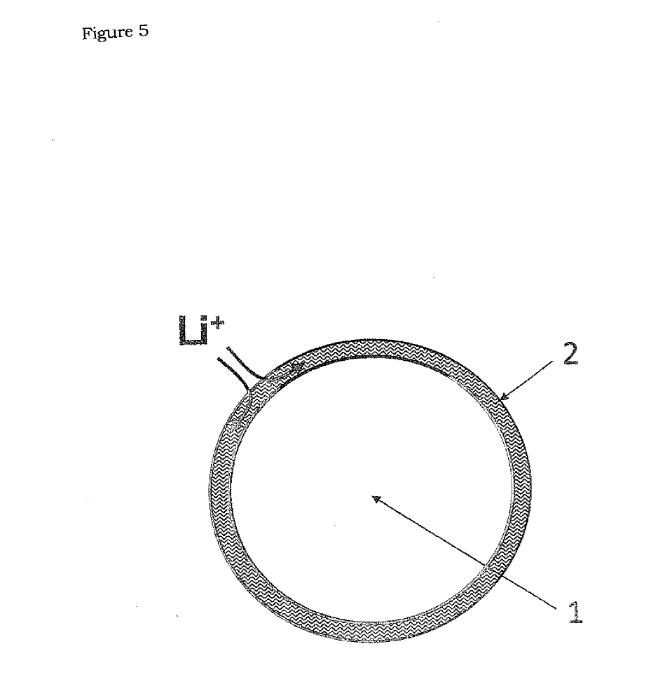

FIG. 5 shows the construction of an electrode material 1 coated with hybrid polymer 2, as a model.

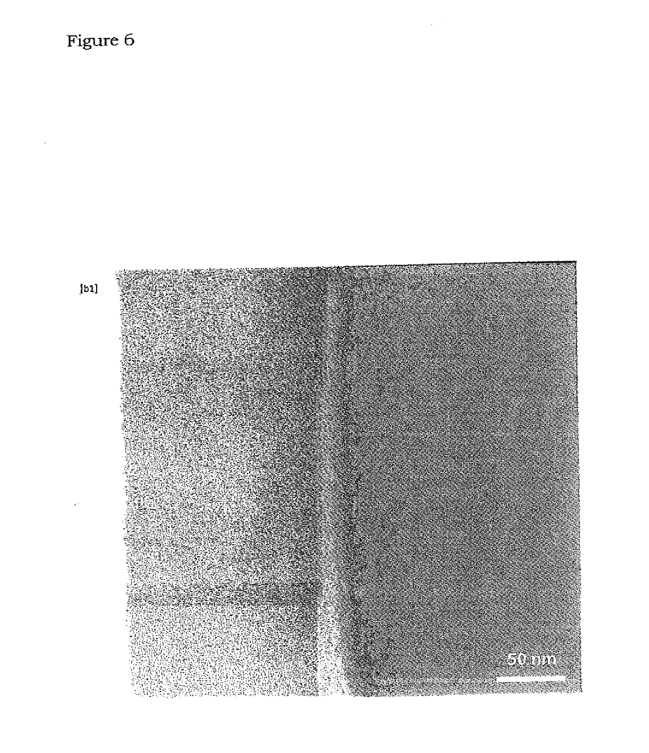

FIG. 6 shows the TEM image of the profile of an Li(Ni,Co,Mn)O₂ particle coated with hybrid polymer.

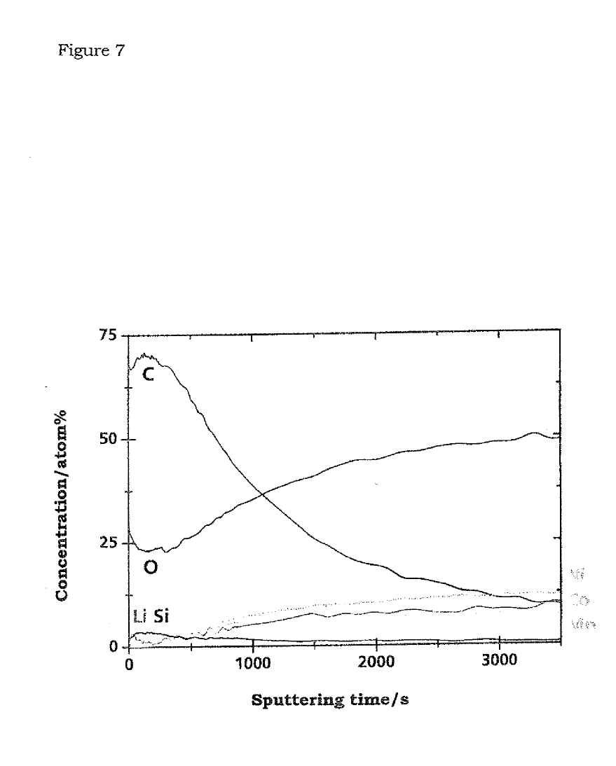

FIG. 7 shows the detection of a complete hybrid polymer coating on Li(Ni,Co,Mn)O₂ by means of an ESCA depth profile.

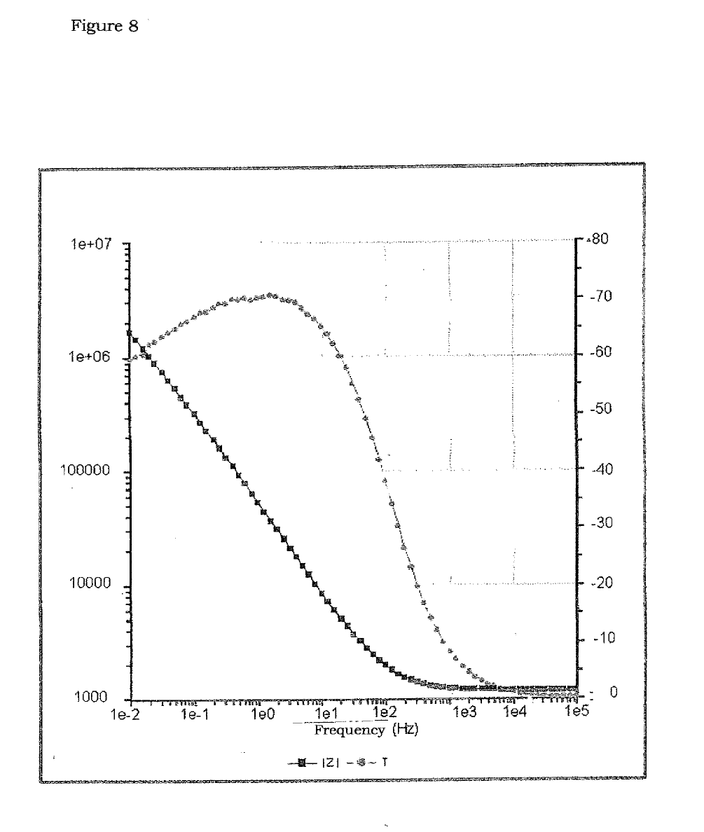

FIG. 8 shows a conductivity measurement of a hybrid polymer material comprising LiClO₄.

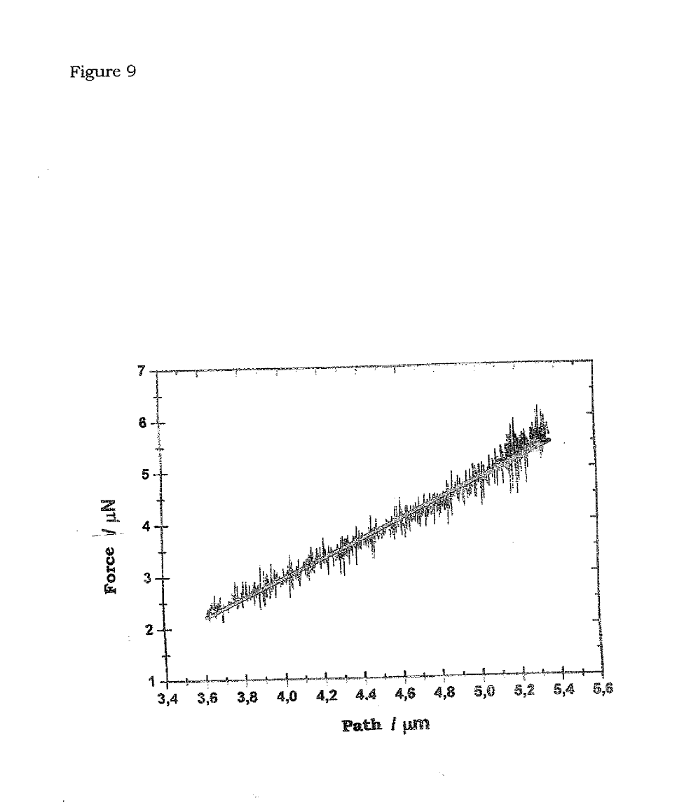

FIG. 9 shows the force-path diagram of an elastic hybrid polymer material (grey: measurement, black: fit of the measurement).

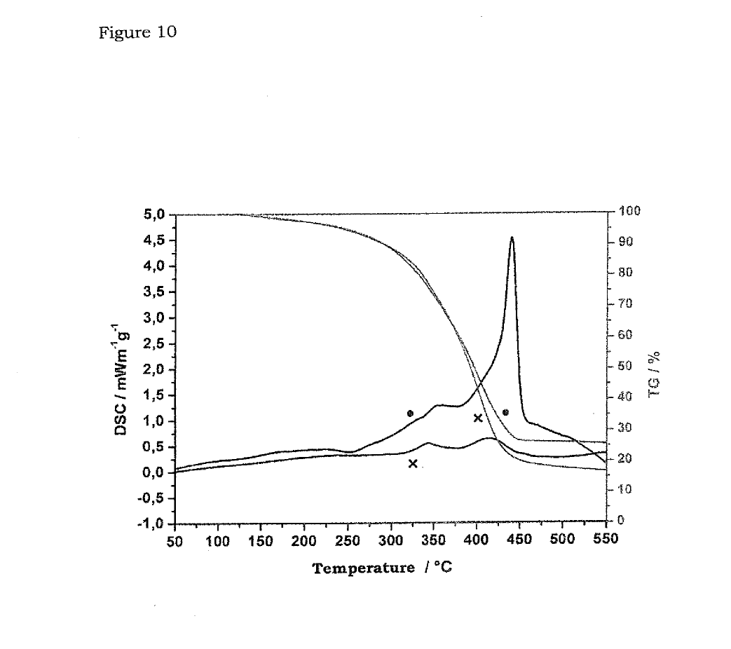

FIG. 10 shows the DSC/TG measurements under an argon atmosphere of hybrid material with LiClO₄ (•) or without LiClO₄ (x).

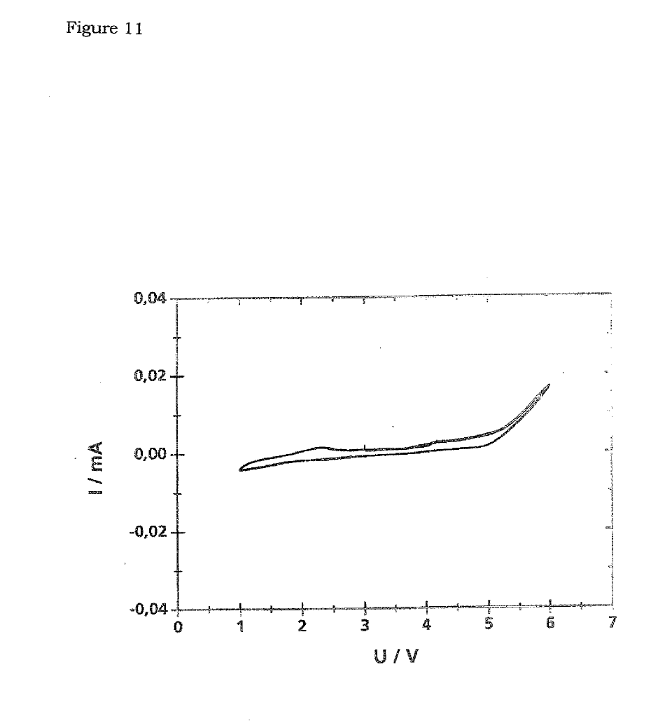

FIG. 11 shows the cyclic voltammogram of a hybrid polymer material comprising LiClO₄ (AE=Pt and Ge═Li).

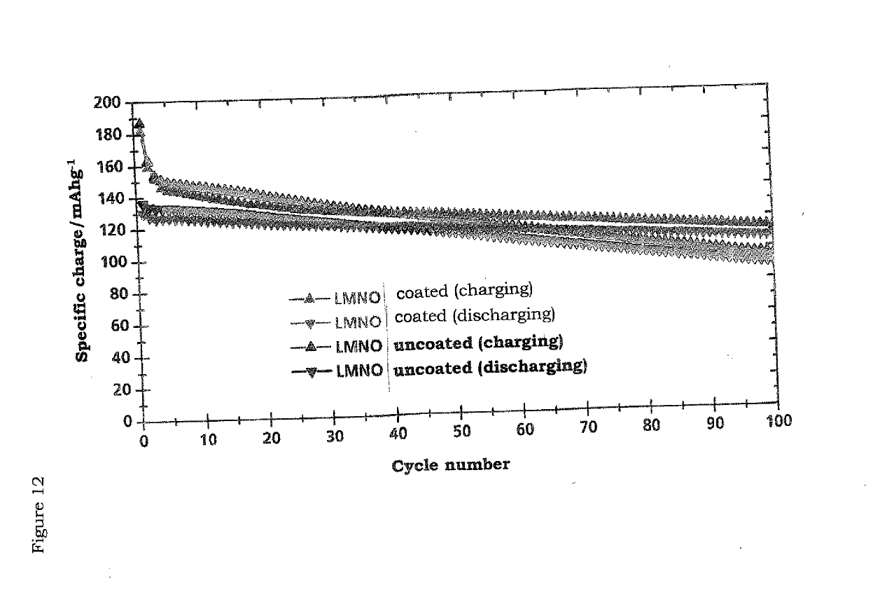

FIG. 12 shows charging measurements (triangles with tip at the top) and discharging measurements (triangles with tip at the bottom) of Li(Mn,Ni)₂O₄ which is coated with hybrid polymer (grey, less steeply falling curves) or is uncoated (black, more steeply falling curves).

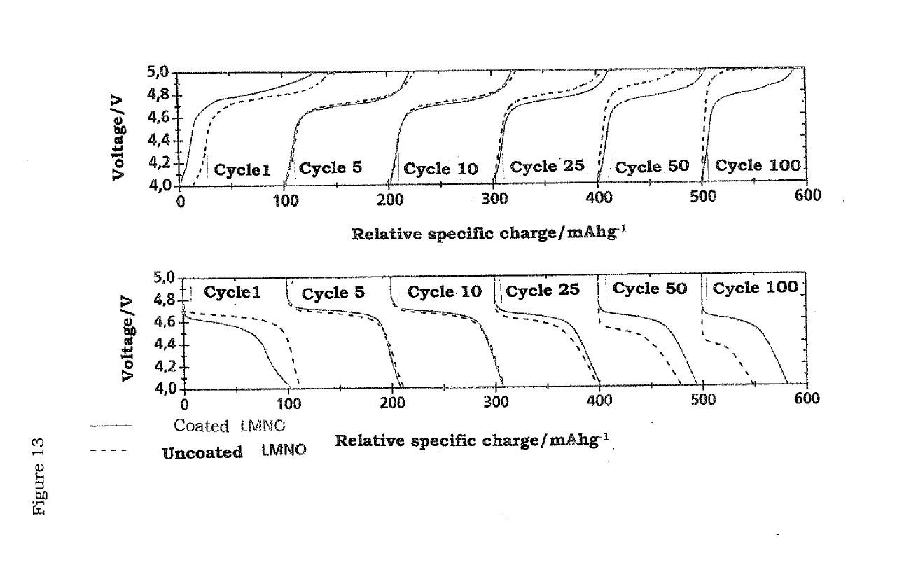

FIG. 13 shows the charging curves (upper diagram) and discharging curves (lower diagram) of Li(Mn,Ni)₂O₄ which is coated with hybrid polymer (grey curves with continuous lines) or is uncoated (black curves with broken lines) of different cycles.

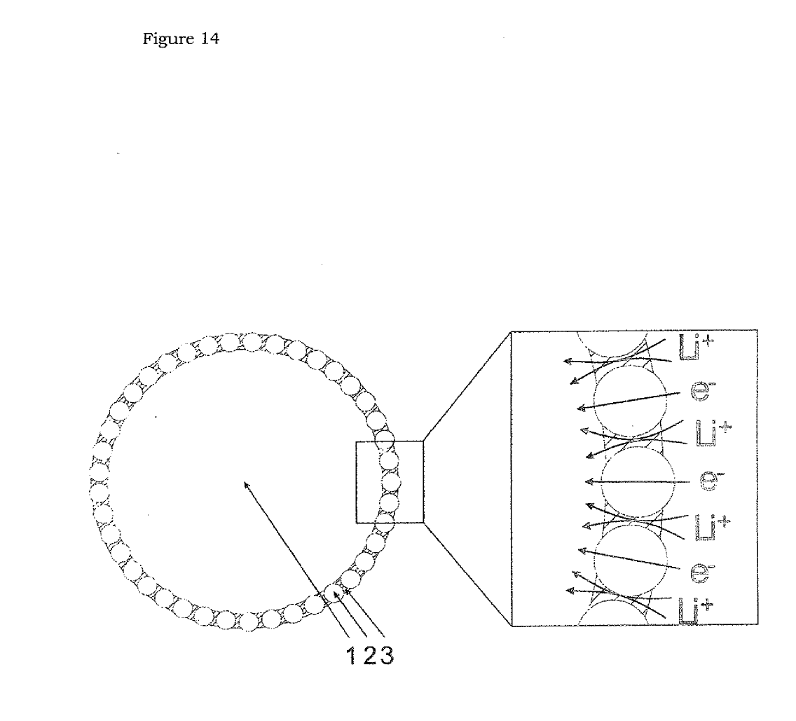

FIG. 14 describes a particulate electrode material 1 with a nanostructured coating consisting of a crystalline, particulate inorganic material 2 and an inorganic-organic hybrid polymer 3. The coating has both electron-conducting and ion-conducting regions (see enlarged region).

### EXAMPLE 1

### Method for the Production of a Nanostructured Particulate Coating on a Particulate Electrode Material

One example is the fine-grain zinc oxide coating on Li(Ni,Co,Mn)O₂ consisting of tiny (d<20 nm), almost identically large and uniformly disposed zinc oxide crystallites.

The production is possible via a modified Pechini sol-gel method, a further development of a process for the production of unstructured particle coatings:

500 ml of water and ethanol in the ratio 1:8 are filled into a 1000 ml flask. With continuous agitation, firstly 1.34 g of zinc acetate is added and subsequently is brought into solution by adding 500 μl of nitric acid (10 mol/l) in drops. Subsequently, 2.57 g of citric acid and 30 g of polyethylene glycol are added.

In parallel thereto, 40 g of the Li(Ni,Co,Mn)O₂ to be coated is dispersed in a further 100 ml of the solvent (water and ethanol in the ratio 1:8).

After one hour of agitation, the 100 ml of solvent is added to the Li(Ni,Co,Mn)O₂ particles of the coating solution. The mixture is thereafter agitated for a further 24 hours.

The coated particles are subsequently centrifuged off and predried at a temperature of 100° C. for 2 hours.

Thereafter, the coated particles are heated to a temperature of 600° C. at a heating rate of 5° C. per minute and sintered for 30 minutes.

### EXAMPLE 2

### Method for the Production of a Hybrid Polymer Coating on a Particulate Electrode Material

Synthesis of an Li⁺-conductive hybrid polymer (=coating material)

In a 250 ml flask, 152 g (0.29 mol) of 2-methoxypolyethylene oxypropyl trimethoxysilane is agitated with 2.634 of lithium hydroxide (mixture 1).

In parallel, 23.6 g (0.1 mol) of 3-glycidyl oxypropyl trimethoxysilane with 140 g of diethylcarbonate are weighed into a 100 ml flask and 2.7 g (0.15 ml) of distilled water is added (mixture 2). The mixture is agitated.

After reaching the clear point of mixture 2, the homogenous mixture 1 is added to this.

After a few days, the solvent is centrifuged off at 40° C. and at a pressure of 28 mbar.

### Coating Method

In a 1 l flask, 30 g of electrode material is weighed in under argon. Subsequently, 400 g of dimethylcarbonate and 0.9 g of coating material (optionally with lithium salt or 0.01 g of boron trifluoride ethylamine complex) are weighed in.

The flask is agitated slowly on the rotational evaporator rinsed with argon. After approx. 30 min, the centrifugation is begun at 40° C.—up to a pressure of 12 mbar.

Finally, the temperature is increased to 80° C. and centrifugation takes place for 1 hour under these conditions.

### EXAMPLE 3

### Method for the Production of a Nanostructured Particulate Coating and a Hybrid Polymer Coating on a Particulate Electrode Material

Step 1: Synthesis of the e⁻-Conductive Coating Made of Metal Oxide Crystallites

500 ml of water and ethanol in the ratio 1:8 is filled into a 1000 ml flask.

With continuous agitation, firstly 1.34 of zinc acetate (optionally with a small proportion of aluminium acetate) is added and subsequently brought into solution by adding 500 μl of nitric acid (10 mol/1) in drops.

Subsequently, 2.57 g of citric acid and 30 g of polyethylene glycol are added. In parallel thereto, 40 g of the Li(Ni,Co,Mn)O₂ to be coated is dispersed in a further 100 ml of the solvent (water and ethanol in the ratio 1:8).

After one hour of agitation, the 100 ml of solvent with the Li(Ni,Co,Mn)O₂ particles is added to the coating solution. The mixture is agitated for a further 24 hours.

The coated particles are subsequently centrifuged off and predried at a temperature of 100° C. for 2 hours.

Thereafter, the coated particles are brought to a temperature of 600° C. at a heating rate of 5° C. per minute and sintered for 30 minutes.

### Step 2: Synthesis of the Coating Regions Made of Lit-Conductive Hybrid Polymer

In a 250 ml flask, 152 g (0.29 mol) of 2-methoxypolyethylene oxypropyl trimethoxysilane is agitated with 2.634 g of lithium hydroxide (mixture 1).

In parallel, 23.6 g (0.1 mol) of 3-glycidyl oxypropyl trimethoxysilane with 140 g diethylcarbonate is weighed into a 100 ml flask and 2.7 g (0.15 mol) of distilled water is added (mixture 2). The mixture is agitated.

After reaching the clear point of mixture 2, the homogeneous mixture 1 is added to this.

After a few days, the solvent is centrifuged off from the coating material at 40° C. and 28 mbar.

In a 1 l flask, 30 g of the electrode material to be coated further is weighed in under argon. Subsequently, 400 g of dimethylcarbonate and 0.9 g of coating material (optionally lithium salt or 0.01 g of boron trifluoride ethylamine complex) is weighed in.

The flask is agitated slowly in the rotational evaporator rinsed with argon. After approx. 30 min, the centrifugation is begun at 40° C. up to 12 mbar.

Finally, the temperature is increased to 80° C. and centrifugation takes place for 1 hour under these conditions.

1. A coated particulate electrode material, comprising a particulate electrode material selected from the group consisting of lithium-intercalating and lithium-deintercalating substances, which material has, at least in regions,
a) a nanostructured coating which comprises at least one crystalline, particulate, inorganic material or consists thereof; and/or
b) a hybrid polymer coating which comprises at least one inorganic-organic hybrid polymer or consists thereof.

2. The coated electrode material according to claim 1, wherein the inorganic material has a particle size in the range of 0.5 to 500 nm.

3. The coated electrode material according to claim 1, wherein the inorganic material concerns a semiconducting to conducting material.

4. The coated electrode material according to claim 1, wherein the inorganic material is selected from the group consisting of chalcogenides, halogenides, silicides, borides, nitrides, phosphides, arsenides, antimonides, carbides, carbonites, carbonitrides, and oxynitrides of the elements Zn, Al, In, Sn, Ti, Si, Li, Zr, Hf, V, Nb, Cr, Mo, W, Mn, Co, Ni, Fe, Ca, Ta, Cd, Ce, Be, Bi, Sc, Rh, Pd, Ag, Cd, Ru, La, Pr, Nd, Sm, Eu, Gd, Mg, Cu, Y, Fe, Ga, Ge, Hg, S, Se, Sb, Te, B, C and I, and also the pure elements and mixtures or combinations of the same.

5. The coated electrode material according to claim 1, wherein the nanostructured inorganic coating is porous at least in regions.

6. The coated electrode material according to claim 1 wherein the hybrid polymer coating has a layer thickness in the range of 1 to 500 nm.

7. The coated electrode material according to claim 1, wherein the inorganic-organic hybrid polymer comprises an inorganic-oxidic framework consisting of Si—O—Li bonds and/or Si—O—Li⁺, this framework optionally comprising in addition oxidic heteroatoms selected from the group consisting of B, Zr, Al, Ti, Ge, P, As, Mg, Ca, Cr, W and/or organic substituents (primarily bonded to Si) of vinyl, alkyl, acryl, methacryl, epoxy, PEG, aryl, styryl, (per)fluoroalkyl, (per)fluoroaryl, nitrile, isocyanate or organic carbonates, and/or vinyl-, allyl-, acryl-, methacryl-, styrene-, epoxy- or cyanurate functionalities.

8. The coated electrode material according to claim 1, wherein the inorganic-organic hybrid polymer comprises a lithium salt, the lithium salt being preferably selected from the group consisting of LiClO₄, LiAlO₄, LiAlCl₄, LiPF₆, LiSiF₆, LiBF₄, LiBr, LiI, LiSCN, LiSbF₆, LiAsF₆, LiTfa, LiDFOB, LiBOB, LiTFSI, LiCF₃SO₃, LiC₄F₉SO₃, LiN(CF₃SO₂)₂, LiN(C₂F₅SO₂)₂, LiC(CF₃SO₂)₃, LiC(C₂F₅SO₂)₃.

9. The coated electrode material according to claim 1, wherein the hybrid polymer coating is a nanostructured hybrid polymer coating and/or the hybrid polymer coating has a lithium-ion conductivity in the range of 10⁻⁷ S/cm to 1 S/cm.

10. The coated electrode material according to claim 1, wherein the hybrid polymer coating is elastic and has preferably a modulus of elasticity of 10 kPa to 100 MPa, and/or in that the hybrid polymer is degraded thermally only from temperatures above 300° C.

11. The coated electrode material according to claim 1, wherein the electrode material coated with the hybrid polymer is electrochemically stable at potentials ≧5 V vs Li/Li⁺ and/or has an operational life of 100 to 100,000 cycles.

12. The coated electrode material according to claim 1, wherein the crystalline, particulate, inorganic material is electron-conducting and/or the inorganic-organic hybrid polymer is ion-conducting.

13. The coated electrode material according to claim 1, wherein the coated electrode material is suitable for the production of energy stores which have a power density of 1,000 W/kg to 15,000 W/kg and/or an energy density of 150 Wh/kg to 1,000 Wh/kg.

14. The coated electrode material according to claim 1, wherein the electrode material is selected from the group consisting of carbons, alloys of Si, Li, Ge, Sn, Al, Sb, Li₄TiSO₁₂, Li_{4-y} A_{y}Ti₅₋ₓMₓO₁₂ (A=Mg, Ca, Al; M=Ge, Fe, Co, Ni, Mn, Cr, Zr, Mo, V, Ta or a combination thereof), Li(Ni,Co,Mn)O₂, Li₁₊ₓ(M,N)₁₋₁O₂ (M=Mn, Co, Ni or a combination thereof; N=Al, Ti, Fe, Cr, Zr, Mo, V, Ta, Mg, Zn, Ga, B, Ca, Ce, Y, Nb, Sr, Ba, Cd or a combination thereof), (Li,A)ₓ(M,N)_{z}O_{v-w}X_{w} (A=alkali-, alkaline earth metal, lanthanoide or a combination thereof; M=Mn, Co, Ni or a combination thereof; N=Al, Ti, Fe, Cr, Zr, Mo, V, Ta, Mg, Zn, Ga, B, Ca, Ce, Y, Nb, Sr, Ba, Cd or a combination thereof; X=F, Si), LiFePO₄, (Li,A)(M,B)PO₄ (A or B=alkali-, alkaline earth metal, lanthanoide or a combination thereof; M=Fe, Co, Mn, Ni, Ti, Cu, Zn, Cr or a combination thereof), LiVPO₄F, (Li,A)₂(M,B)PO₄F (A or B=alkali-, alkaline earth metal, lanthanoide or a combination thereof; M=Fe, Co, Mn, Ni, Ti, Cu or a combination thereof), Li₃V₂PO₄, Li(Mn,Ni)₂O₄, Li₁₊ₓ(M,N)₂₋ₓO₄ (M=Mn; N=Co, Ni, Fe, Al, Ti, Cr, Zr, Mo, V, Ta or a combination thereof) and mixtures or combinations of the same.

15. A method for coating particulate electrode material with a particulate, nanostructured coating, in which
a) at least one precursor of a metal or metalloid compound or a metal or metalloid compound is dissolved or dispersed in a solvent,
b) at least one polymerisible, organic substance is added;
c) the solution is contacted with at least one particulate electrode material, electrode material with a nanostructured coating being produced; and
d) the coated electrode material is isolated and tempered.

16. The method according to claim 15, wherein the solvent in step a) is selected from the group consisting of inorganic and organic solvents.

17. The method according to claim 15, wherein, before or after step a), the at least one precursor of a metal or metalloid compound or the metal or metalloid compound is contacted with an inorganic or organic acid.

18. The method according to claim 15, wherein the polymerisable, organic substance in step b) comprises an acid.

19. The method according to claim 15, wherein the polymerisable, organic substance in step b) comprises an alcohol.

20. The method according to claim 15, wherein the tempering comprises:
a) drying of the particles, preferably at a temperature of 80 to 120° C.; and/or
b) pyrolysis and/or crystallisation of the particles, preferably at a temperature of 500 to 700° C.

21. A method for coating a particulate electrode material with a hybrid polymer coating, in which
i) a sol made of an organically modified, polysiloxane-containing material is provided and is mixed with electrode material, selected from the group consisting of lithium-intercalating and lithium-deintercalating substances, and optionally with at least one organic solvent; and
ii) the organic solvent is separated, electrode material with a nanostructured hybrid polymer coating being produced; and
iii) the electrode material with the nanostructured hybrid polymer coating is isolated, dried and hardened.

22. The method according to claim 21, wherein, in addition in step i), at least one of a lithium salt and at least one hardener is added.

23. The method according to claim 21, wherein the organic solvent is selected from the group consisting of organic solvents which dissolve the organically modified, polysiloxane-containing material.

24. The method according to claim 21, wherein
a) drying takes place at a temperature of 30 to 50° C. for 20 to 40 min; and/or
b) hardening takes place at a temperature of 70 to 150° C. for 0.5 to 5 hours.

25. A method for coating particulate electrode material with a nanostructured coating comprising a crystalline inorganic material and an inorganic-organic hybrid polymer, comprising the steps:
a) implementation of a first method, the first method being a method according to claim 15; and
b) implementation of a second method, the second method being a method according to claim 21, with the proviso that coated electrode material from step d) of the first method is used as electrode material in step i) of the second method.

26. Use of at least one of
a) inorganic materials, selected from the group consisting of chalcogenides, halogenides, silicides, borides, nitrides, phosphides, arsenides, antimonides, carbides, carbonites, carbonitrides and oxynitrides of the elements Zn, Al, In, Sn, Ti, Si, Li, Zr, Hf, V, Nb, Cr, Mo, W, Mn, Co, Ni, Fe, Ca, Ta, Cd, Ce, Be, Bi, Sc, Rh, Pd, Ag, Cd, Ru, La, Pr, Nd, Sm, Eu, Gd, Mg, Cu, Y, Fe, Ga, Ge, Hg, S, Se, Sb, Te, B, C and I, and also the pure elements and mixtures or combinations of the same; and
b) a hybrid polymer comprising a sol-gel material which is produced from organically substituted silanes with hydrolysable functionalities and optionally comprises lithium salt;
for coating of particulate electrode material or catalyst material.

27. Use of the coated electrode material according to claim 1 in energy stores.
